(19) United States
(12) Patent Application Publication
(10) Pub. No.: US 2020/0229643 A1
(43) Pub. Date: Jul. 23, 2020

(54) HANDLE ASSEMBLY FOR A BARBECUE GRILL

(71) Applicant: Kiosky CHUNG, Taichung City (TW)

(72) Inventor: Kiosky CHUNG, Taichung City (TW)

(21) Appl. No.: 16/251,004

(22) Filed: Jan. 17, 2019

(51) Int. Cl. A47J 37/07

(52) U.S. Cl. CPC A47J 37/0786

(57) ABSTRACT

A handle assembly includes a metal handle and a grip. The metal handle includes two lateral sections extending from the middle section. The grip includes two shells. The first shell includes two minor portions extending from a major portion, thereby providing a space. The second shell includes two secondary portions formed at two ends of the primary portion. The shell is shaped in compliance with the space. The middle section is entirely inserted in the space. Each of the lateral sections is partially inserted in the space. The second shell is entirely inserted in the space. The middle section is sandwiched by the major portion and the primary portion. A portion of each of the lateral sections is sandwiched between a one of the minor portions and a one of the secondary portions. Thus, the metal handle is kept in position relative to and between the first and second shells.

### BACKGROUND OF INVENTION

The present invention relates to a barbecue grill and, more particularly, to a handle assembly for a barbecue grill.

### 2. RELATED PRIOR ART

Referring to FIG. 7, a barbecue grill 90 includes a bowl 92, a lid 94, legs 96 and two conventional handle assemblies 98. The bowl 92 is supported on the legs 96. The lid 94 is pivotally connected to the bowl 92 between an opening position and a closing position. One of the handle assemblies 98 is connected to the bowl 92. The other handle assembly 98 is connected to the lid 94. Thus, a user can maneuver the bowl 92 and the lid 94 by the handle assemblies 98 without getting burned while cooking with the barbecue grill 90. Each of the handle assemblies 98 includes a metal handle 981 and a grip 985. The metal handle 981 is an inverted U-shaped element formed with two ends connected to the bowl 92 or the lid 94. The grip 985 is made of a non-metal material with low thermal conductivity. A middle section of the metal handle 981 is inserted in the grip 985. Thus, the grip 985 is not rotatable relative to the metal handle 981. Thus, heat cannot be transferred to the user's hand from the metal handle 981 via the grip 985 in the operation of the barbecue grill 90.

Therefore, the present invention is intended to obviate or at least alleviate the problems encountered in prior art.

### SUMMARY OF INVENTION

It is the primary objective of the present invention to provide a barbecue grill with a simple, inexpensive and easy-to-maintain handle assembly.

To achieve the foregoing objective, the handle assembly includes a metal handle and a grip. The metal handle includes two lateral sections extending from the middle section. The lateral sections are connected to a barbecue grill. The grip includes two shells. The first shell includes two minor portions extending from a major portion. The major portion includes two long walls. Each of the minor portions includes two walls each of which is made in one piece with a corresponding one of the long walls, thereby providing a space. The second shell includes two secondary portions formed at two ends of the primary portion so that the shell is shaped in compliance with the space. The middle section is entirely inserted in the space. Each of the lateral sections is partially inserted in the space. The second shell is entirely inserted in the space. The middle section is sandwiched by the major portion and the primary portion. A portion of each of the lateral sections is sandwiched between a corresponding one of the minor portions and a corresponding one of the secondary portions. Thus, the metal handle is kept in position relative to and between the first and second shells.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a handle assembly according to the preferred embodiment of the present invention;

FIG. 2 is an exploded view of the handle assembly shown in FIG. 1;

FIG. 3 is a perspective view of a metal handle and a first shell of the handle assembly shown in FIG. 1;

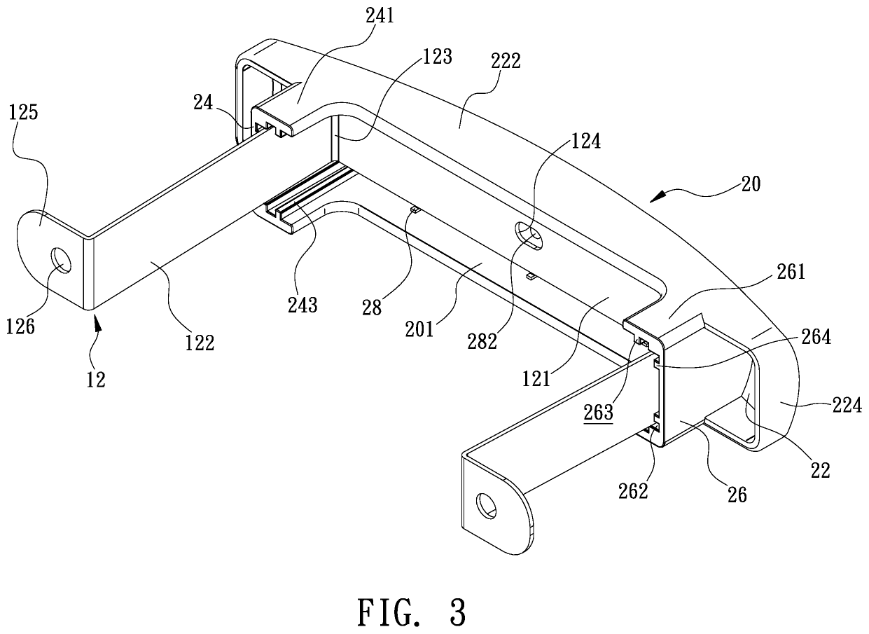

FIG. 4 is a perspective view of the metal handle and a second shell of the handle assembly shown in FIG. 1;

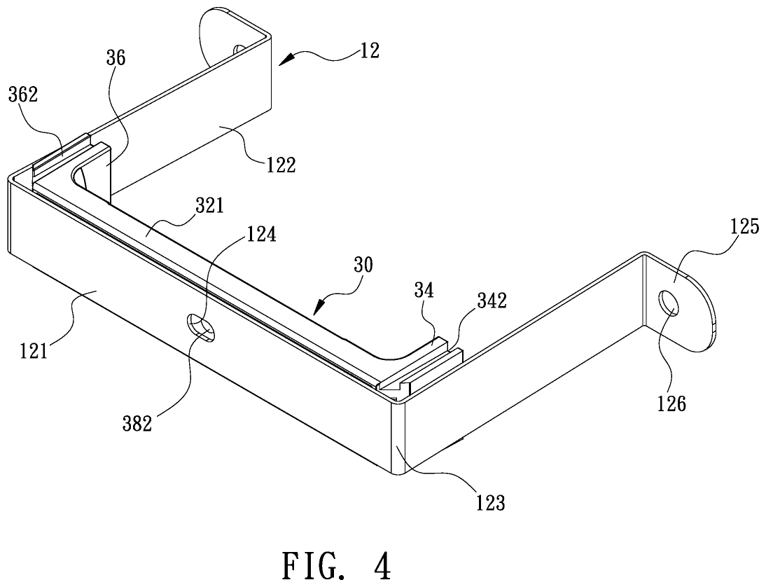

FIG. 5 is a cross-sectional view of the handle assembly shown in FIG. 1;

FIG. 6 is a cross-sectional view of the handle assembly taken along a line A-A shown in FIG. 5; and

FIG. 7 is a perspective view of a barbecue grill equipped with a conventional handle assembly.

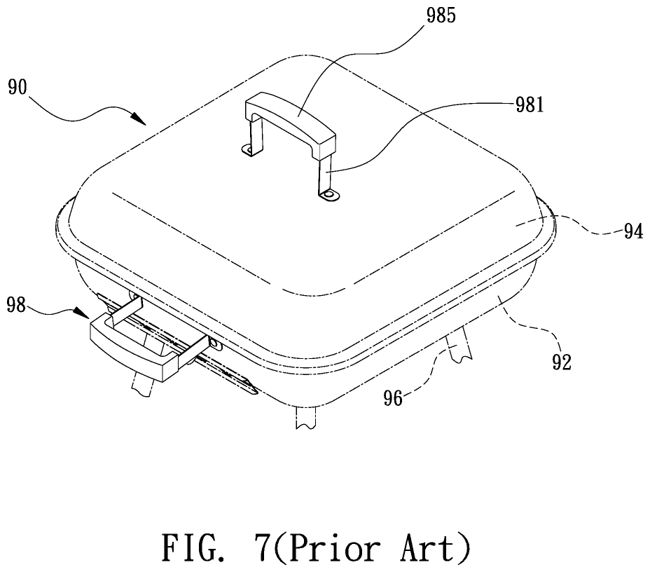

### DETAILED DESCRIPTION OF PREFERRED EMBODIMENT

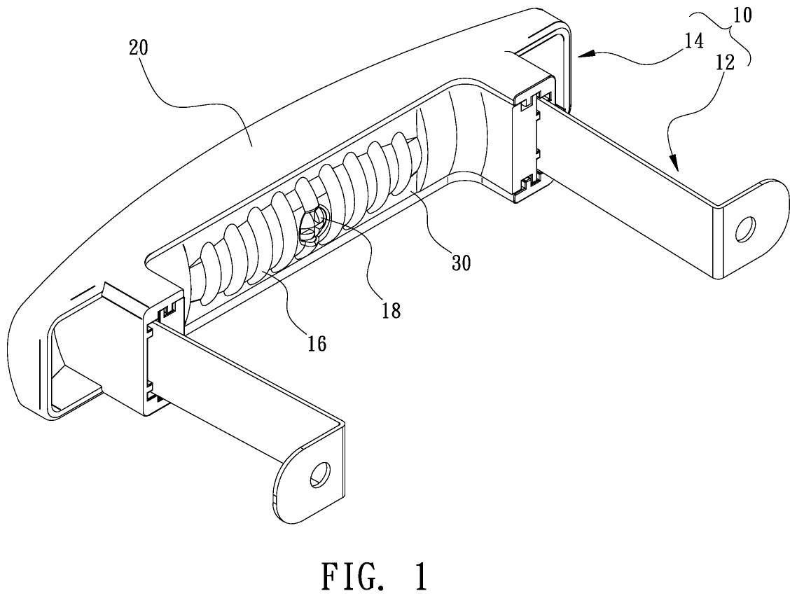

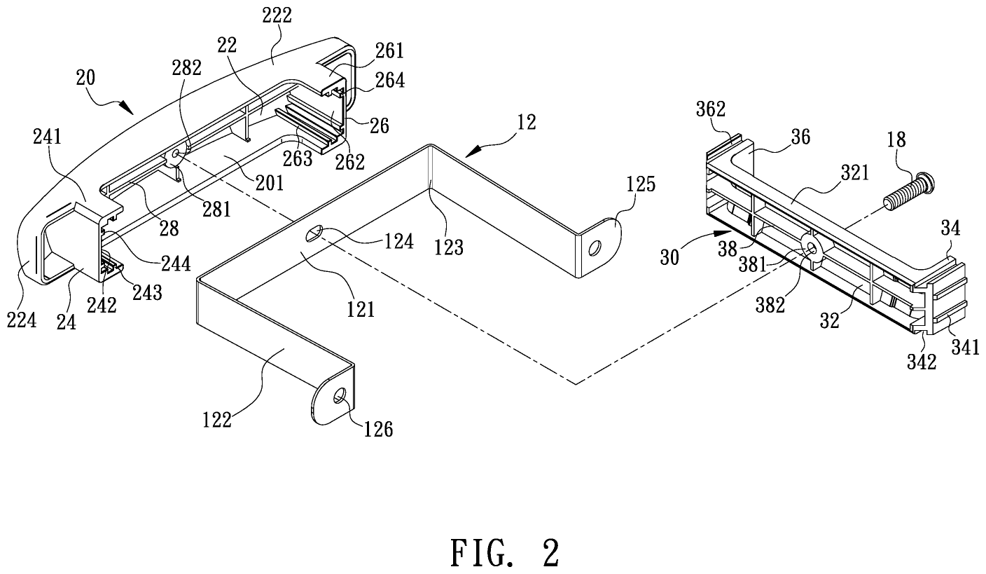

Referring to FIGS. 1 and 2, a handle assembly 10 includes a metal handle 12 and a non-metal grip 14 according to the preferred embodiment of the present invention. In use, the metal handle 12 is connected to a lid or a bowl of a barbecue grill such as the barbecue grill 90 described in the RELATED PRIOR ART, and the grip 14 is connected to the metal handle 12.

The metal handle 12 is made of a metal strip formed with a middle section 121 and two lateral sections 122. The middle section 121 is made with a slot 124. The lateral sections 122 extend in a same direction from the middle section 121, with a bent section 123 formed between the middle section 121 and each of the lateral sections 122. Each of the lateral sections 122 is formed with a bent end 125. Each of the ends 125 is made with an aperture 126.

A fastener such as a rivet or threaded bolt is inserted in the aperture 126 of the ends 125 each of and a proper portion of the lid or the bowl so that metal handle 12 is connected to the lid or the bowl. The lateral sections 122 keep the middle section 121 at a proper distance from the lid or the bowl.

The grip 14 includes two shells 20 and 30. The first shell 20 includes a major portion 22 and two minor portions 24 and 26. The major portion 22 includes two long walls 222 extending between two short walls 224. The minor portions 24 and 26 extend from the major portion 22 at the right angle. The minor portion 24 includes two walls 241 formed on two sides of a groove 242. Each of the walls 241 and a corresponding one of the long walls 222 are made in one piece. The minor portion 26 includes two walls 261 formed on two sides of a groove 262. Each of the walls 261 and a corresponding one of the long walls 262 are made in one piece. The long walls 222 and the walls 241 and 261 together define a space 201 in the form of a horseshoe. The minor portions 24 and 26 are located between the short walls 224.

In another embodiment, the short walls 224 can be omitted. In another embodiment, the portion of each of the walls 222 extending beyond the minor portion 24 or 26 can be omitted.

The second shell 30 includes a primary portion 32 formed between two secondary portions 34 and 36. The second shell 30 is shaped in compliance with the space 201.

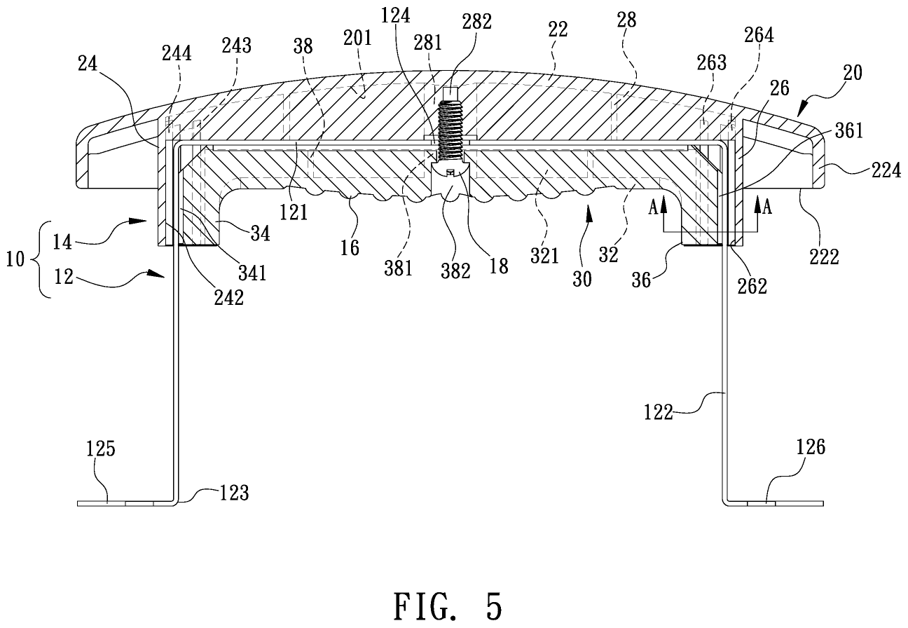

Referring to FIG. 5, in assembly, the middle section 121 of the metal handle 12 is entirely inserted in the space 201 of the first shell 20 so that each of the lateral sections 122 of the metal handle 12 is partially inserted in the space 201 of the first shell 20. The primary portion 32 of the second shell 30 is located against the middle section 121 of the metal handle 12 so that each of the secondary portions 34 and 36 of the second shell 30 is located against or near a corresponding one of the lateral sections 122 of the metal handle 12. The second shell 30 is entirely inserted in the space 201 of the first shell 20. The middle section 121 of the metal handle 12 is sandwiched between the major portion 22 of the first shell 20 and the primary portion 32 of the second shell 30. A portion of one of the lateral sections 122 of the metal handle 12 is sandwiched between the minor portion 24 of the first shell 20 and the secondary portion 34 of the second shell 30. A portion of the other lateral section 122 of the metal handle 12 is sandwiched between the minor portion 26 of the first shell 20 and the secondary portion 36 of the second shell 30.

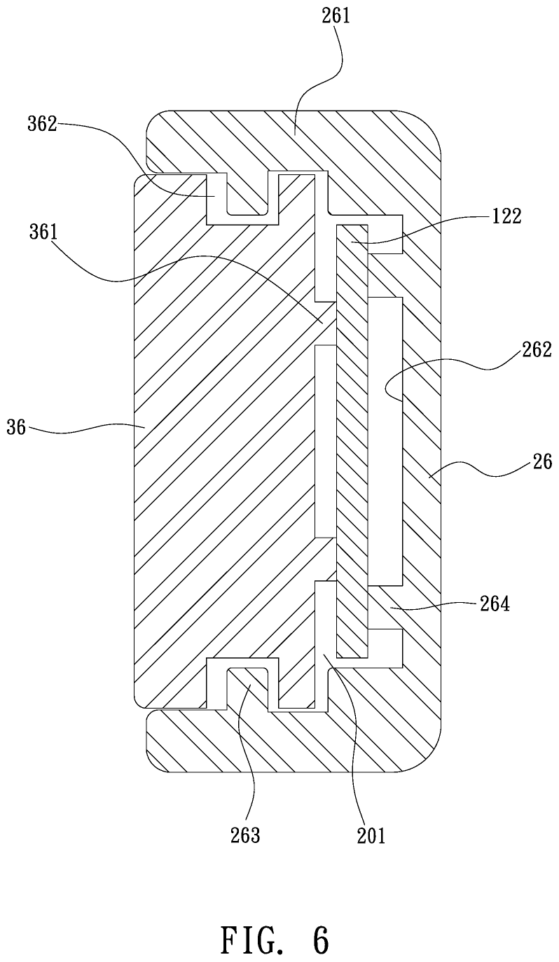

Referring to FIGS. 2, 5 and 6, the first shell 20 further includes multiple reinforcing ribs 28 extending on a side of the major portion 22, between the long walls 222, between the minor portions 24 and 26. The reinforcing ribs 28 intersect one another. The reinforcing ribs 28 reinforce the first shell 20. Furthermore, the first shell 20 includes a cylinder 281 formed amid the reinforcing ribs 28. The cylinder 281 includes a screw hole screw hole 282.

The second shell 30 further includes multiple reinforcing ribs 38 extending on a side of the primary portion 32, between two walls 321 of the primary portion 32. The reinforcing ribs 38 intersect one another. The reinforcing ribs 38 reinforce the second shell 30. The reinforcing ribs 38 are located corresponding to the reinforcing ribs 28. The second shell 30 further includes a cylinder 381 amid the reinforcing ribs 38. The cylinder 381 includes a countersink hole 382 corresponding to the screw hole 282.

A threaded bolt 18 is inserted in the screw hole 282 through the countersink hole 382 and the slot 124, thereby connecting the first shell 20 to the second shell 30 in a detachable manner. Now, the middle section 121 of the metal handle 12 is located between and compressed by the reinforcing ribs 28 of the major portion 22 of the first shell 20 and the reinforcing ribs 38 of the primary portion 32 of the second shell 30. Thus, the middle section 121 of the metal handle 12 is kept in position in the space 201.

The groove 242 receives the portion of one of the lateral sections 122. The groove 262 receives the portion of the other lateral section 122. Thus, the grooves 242 and 262 of the first shell 20 guide the lateral sections 122 of the metal handle 12 and the secondary portions 34 and 36 of the second shell 30 into the space 201 of the first shell 20.

The minor portion 24 preferably includes two spacers 244 on a wall of the groove 242. The minor portion 26 preferably includes two spacers 264 on a wall of the groove 262. The secondary portion 34 preferably includes two spacers 341 inserted in the space 201. The secondary portion 36 preferably includes two spacers 361 inserted in the space 201. The spacers 341 are arranged alternate with the spacers 244. One of the lateral sections 122 is in contact with the spacers 341 on a side and in contact with the spacers 244 on another side. The spacers 361 are arranged alternate with the spacers 264. The remaining lateral section 122 is in contact with the spacers 361 on a side and in contact with the spacers 264 on another side. Thus, the lateral sections 122 of the metal handle 12 are kept in position.

Each of the walls 241 includes a track 243. Each of the walls 261 includes a track 263. The secondary portion 34 includes two grooves 342 corresponding to the tracks 243. The secondary portion 36 includes two grooves 362 corresponding to the tracks 263. The grooves 342 receive the tracks 243. The grooves 362 receive the tracks 263. Thus, the secondary portions 34 and 36 of the second shell 30 are guided into the space 201 of the first shell 20.

The second shell 30 includes protuberances 16. The protuberances 16 extend higher than a head of the threaded bolt 18. Thus, a user's hand is protected from the head of the threaded bolt 18. Moreover, the protuberances 16 provide the grip 14 with an anti-slip face so that the user can thinly hold the lid or bowl of the barbecue grill by the grip 14. The shells 20 and 30 are made of a non-metal material with low thermal conductivity. Hence, the grip is made with low thermal conductivity. Thus, heat cannot be transferred to the user's hand from the metal handle 12 via the grip 14 in the operation of the barbecue grill.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A handle assembly comprising:
a metal handle (12) comprising a middle section (121) and two lateral sections (122) extending from the middle section (121), wherein the lateral sections (122) are connected to a barbecue grill (90); and
a grip (14) comprising:
a first shell (20) comprising a major portion (22) and two minor portions (24, 26) extending from the major portion (22), wherein the major portion (22) comprises two long walls (222), and each of the minor portions (24, 26) comprises two walls (241, 261) each of which is made in one piece with one of the long walls (222), thereby providing a space (201);
a second shell (30) comprising a primary portion (32) and two secondary portions (34, 36) formed at two ends of the primary portion (32) so that the shell (30) is shaped in compliance with the space (201);
wherein the middle section (121) is entirely inserted in the space (201), each of the lateral sections (122) is partially inserted in the space (201), the second shell (30) is entirely inserted in the space (201), the middle section (121) is sandwiched by the major portion (22) and the primary portion (32), and a portion of each of the lateral sections (122) is sandwiched between one of the minor portions (24, 26) and one of the secondary portions (34, 36) so that the metal handle (12) is kept in position relative to and between the first and second shells (20, 30).

2. The handle assembly according to claim 1, wherein the first shell (20) comprises reinforcing ribs (28) formed on the major portion (22) and in contact with a side of the middle section (121), and the second shell (30) comprises reinforcing ribs (38) formed on the primary portion (32) and in contact with another side of the middle section (121).

3. The handle assembly according to claim 2, wherein the reinforcing ribs (28) of the first shell (20) intersect one another, and the reinforcing ribs (38) of the second shell (30) intersect one another.

4. The handle assembly according to claim 1, comprising a threaded bolt (18) inserted in the major portion (22) of the first shell (20), the middle section (121) of the metal handle (12) and the primary portion (32) of the second shell (30).

5. The handle assembly according to claim 1, wherein the metal handle (12) comprises a slot (124), the first shell (20) comprises a screw hole (282), the second shell (30) comprises a countersink hole (382), and the threaded bolt (18) is inserted in the screw hole (282) through the slot (124) and the countersink hole (382).

6. The handle assembly according to claim 1, wherein each of the minor portions (24, 26) comprises a groove (242, 262) for receiving one of the lateral sections (122), thereby guiding the lateral sections (122) into the space (201).

7. The handle assembly according to claim 3, wherein each of the minor portions (24, 26) comprises at least one spacer (244, 264) formed on a wall of the groove (242, 262) and in contact with a side of one of the lateral sections (122), wherein each of the secondary portions (34, 36) is formed with at least one spacer (341, 361) and in contact with another side of one of the lateral sections (122).

8. The handle assembly according to claim 1, wherein each of the walls (241, 261) of each of the minor portions (24, 26) comprises a track (243, 263), and each of the secondary portions (34, 36) comprises two grooves (342, 362) each of which receives the track (243, 263) of one of the walls (241, 261) of one of the minor portions (24, 26).
